(19) United States
(12) Patent Application Publication
(10) Pub. No.: US 2026/0065605 A1
(43) Pub. Date: Mar. 5, 2026

(54) METHODS OF SURFACING XR AUGMENTS GENERATED BY ARTIFICIAL INTELLIGENCE AT AUGMENTED REALITY GLASSES, AND SYSTEMS AND DEVICES THEREOF

(71) Applicant: Meta Platforms Technologies, LLC, Menlo Park, CA (US)

(72) Inventors: Ata Dogan, Seattle, WA (US); Christopher E. Balmes, San Francisco, CA (US); Jonathan Faunce, Seattle, WA (US); Tung Him Karpenko, Alhambra, CA (US)

(21) Appl. No.: 19/315,373

(22) Filed: Aug. 29, 2025

Related U.S. Application Data
(60) Provisional application No. 63/690,256, filed on Sep. 3, 2024.

(51) Int. Cl. G06T 19/00; G06Q 50/00

(52) U.S. Cl. CPC G06T 19/006; G06Q 10/40

(57) ABSTRACT

An example method comprises receiving an open-ended query at an augmented-reality (AR) headset, and in response to receiving the open-ended query: determining, via an artificial intelligence (AI), first context for the open-ended query based on first data provided from a camera of the AR headset; and outputting, at the AR headset, a first response based on the open-ended query and the first context. An output modality of the AR headset is selected based on first information included in the first response. The method includes that in response to receiving the open-ended query: determining, via the AI, second context for the open-ended query based on second data provided from the camera of the augmented-reality headset; and outputting, at the AR headset, a second response based on the open-ended query and the second context. An output modality of the AR headset is selected based on second information included in the second response.

### RELATED APPLICATION

This application claims priority to U.S. Provisional Application Serial No. 63/690,256, filed September 3, 2024, entitled “Methods of Surfacing XR Augments Generated by Artificial Intelligence at Augmented Reality Glasses, and Systems and Devices Thereof,” which is incorporated herein by reference.

### TECHNICAL FIELD

This relates generally to using artificial-reality (AI) to generate responses to open-ended queries received at an augmented-reality (AR) headset, where the responses at least partially rely on data from one or more sensors of the AR headset.

### BACKGROUND

As head-wearable devices become more feature dense, interacting with them can become more time consuming and challenging. In essence, users will need to navigate more interfaces to achieve their desired result or may become frustrated and not use the full feature set of the head-wearable devices. Further, while hand-based inputs are sometimes possible they tend to be more difficult and not as feature rich as comparable touch-screen display devices.

As such, there is a need to address one or more of the above-identified challenges, such as finding efficient and frictionless ways of interacting with the available features of an AR device. A brief summary of solutions to the issues noted above are described below.

### SUMMARY

An example method comprises receiving an open-ended query at an augmented-reality (AR) headset. The method also includes, in response to receiving the open-ended query: determining, via an AI (e.g., an AI model, system, and/or agent), first context for the open-ended query based on first data provided from a camera of the AR headset; and outputting, at the AR headset, a first response based on the open-ended query and the first context, wherein an output modality of the AR headset is selected based on first information included in the first response.

In accordance with some embodiments, the methods herein include, in response to receiving the open-ended query: determining, via the AI, second context for the open-ended query based on second data provided from the camera of the augmented-reality headset, wherein the first data is different than the second data; and outputting, at the AR headset, a second response based on the open-ended query and the second context, wherein an output modality of the AR headset is selected based on second information included in the second response.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset (e.g., a mixed-reality (MR) headset or an augmented-reality (AR) headset as two examples), a wrist-wearable device, an intermediary processing device, a smart textile-based garment, etc. For instance, the instructions can be stored on an AR headset or can be stored on a combination of an AR headset and an associated input device (e.g., a wrist-wearable device) such that instructions for causing detection of input operations can be performed at the input device and instructions for causing changes to a displayed user interface in response to those input operations can be performed at the AR headset. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 shows an enhanced view of the XR augment described in reference to FIG. 3 in a detailed view, in accordance with some embodiments.

FIGS. 2A to 2D illustrate embodiments of AI systems presenting user interfaces in response to open-ended queries provided by a user (e.g., voice commands), in accordance with some embodiments.

FIG. 3 shows different XR augments that can be presented to a user based on their open-ended query, in accordance with some embodiments.

FIG. 4 illustrates a high-level breakdown of how an open-ended query is processed and how information is presented, in accordance with some embodiments.

FIG. 5 illustrates examples of different widget AR augments an AI can automatically prepare, in accordance with some embodiments.

FIG. 6 illustrates numerous examples in which an AI can generate different XR augments automatically for presentation at an AR headset, in accordance with some embodiments.

FIG. 7 illustrates a flow diagram of a method of receiving an open-ended query and providing a response based on the open-ended query, in accordance with some embodiments.

FIGS. 8A, 8B, and 8C-1, and 8C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user’s heart rate; (v) peripheral oxygen saturation (SpO₂) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### XR Augment Entry Points for Interacting with An Artificial Intelligence

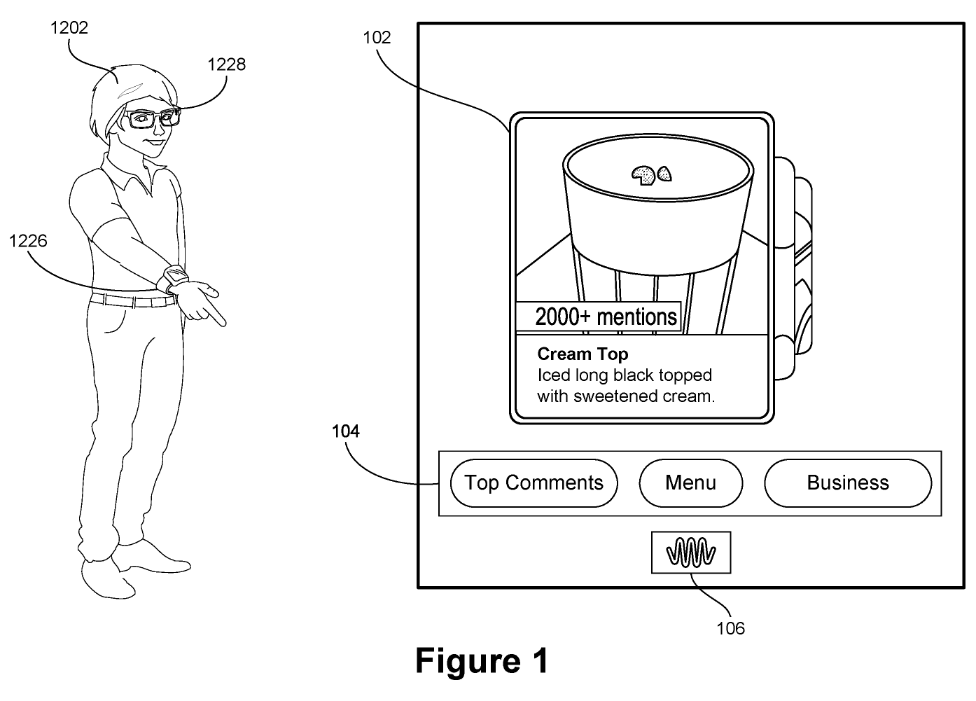

FIG. 1 illustrates the AR device 1228 presenting entry points (e.g., AR augments) for interacting with an artificially intelligent (AI) assistant on a pair of augmented-reality (AR) headset that provides outputs to a user through a combination of one or more of large language models (LLMs) social graphs, and interest graphs, in accordance with some embodiments. FIG. 1 shows an augmented-reality (AR) augment that is displayed to the user and an avenue in which a user can invoke a AI assistant and can also access notifications and recommendations provided by an AI assistant. As shown in FIG. 1, AR augments that are displayed can include a stack of glanceable AR augments 100 that allow for a wearer of the AR headset to quickly view content provided by the AI assistant.

Other AR augments can also include additional AR augments (e.g., AR augment 102, AR augment 104, and AR augment 106) in which additional information related to AR augment 108 of the stack of glanceable AR augments 100 can be presented in response to a selection of them. In addition, another AR augment is also shown that when selected invokes an AI assistant that can respond to open ended queries made by the user.

The AR augments described herein can be interacted with through inputs (e.g., in-air hand gestures) detected by a wrist-wearable device that includes one or more neuromuscular signal sensors (e.g., an EMG sensor). In some embodiments, AR augments can also be interacted with through in-air hand gestures detected by a camera of a augmented-reality headset. These types of inputs are discreet and do not require the intrusiveness of having to provide voice-based inputs to navigate the AR augments.

As shown in FIG. 1, a dynamic UI 102 is displayed, in which the dynamic UI 102 can automatically include text and additional relevant details such as images, mentions, descriptions, etc. The AR device 1228 is also presenting UI elements including an AR augment 104 that includes a predictive intent region that provides additional operations for the head-wearable device to perform. For example, the operations can be created (e.g., predicted) using the user’s social graph, device context, and question. In accordance with some embodiments, the AR augment 106 is provided as an indicator that AI is being used to generate the other AR augments presented.

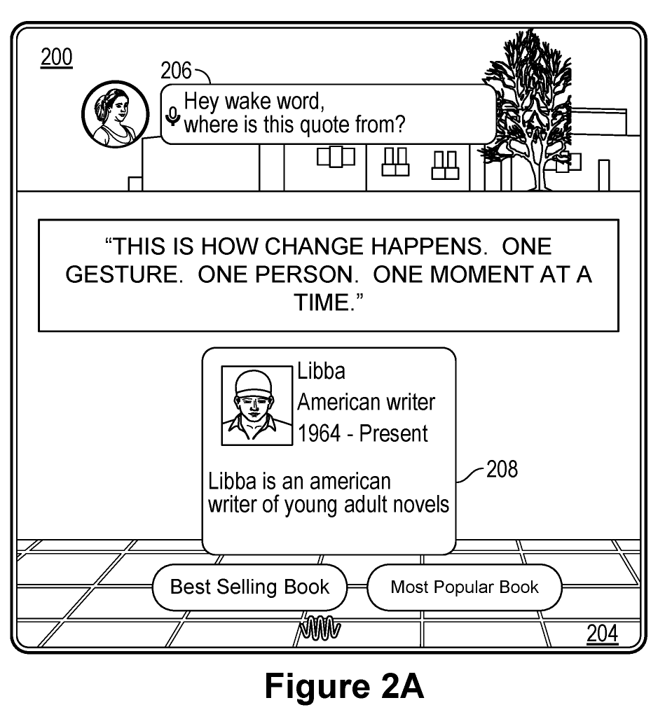

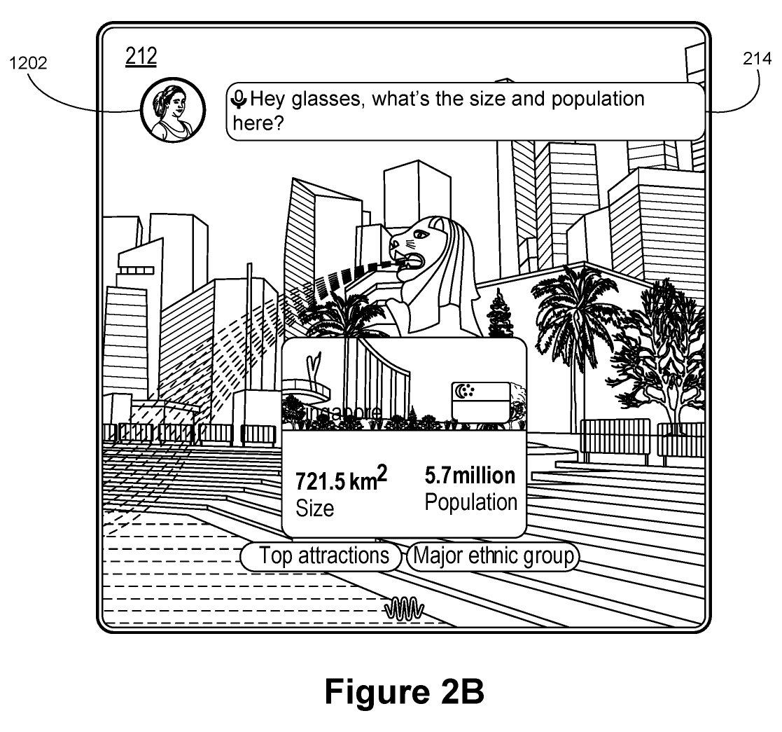

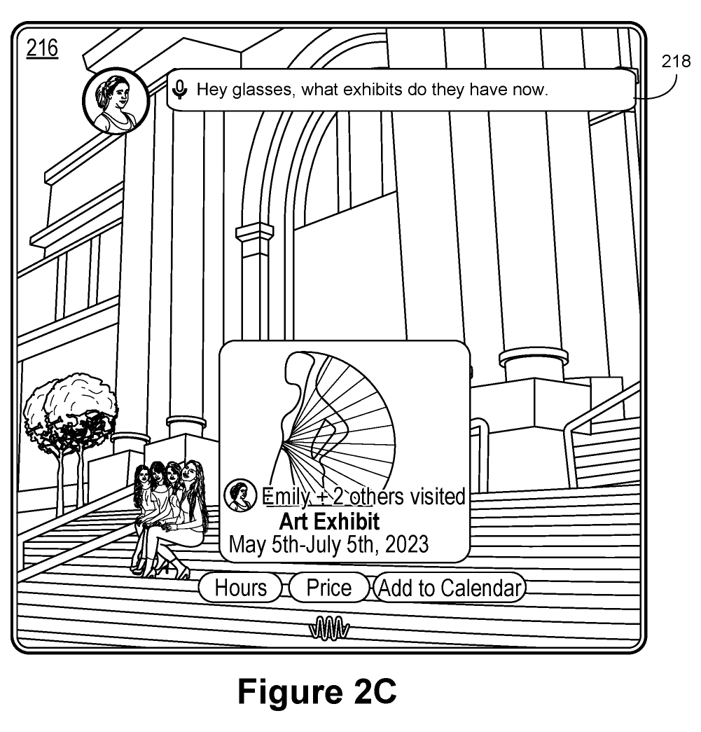

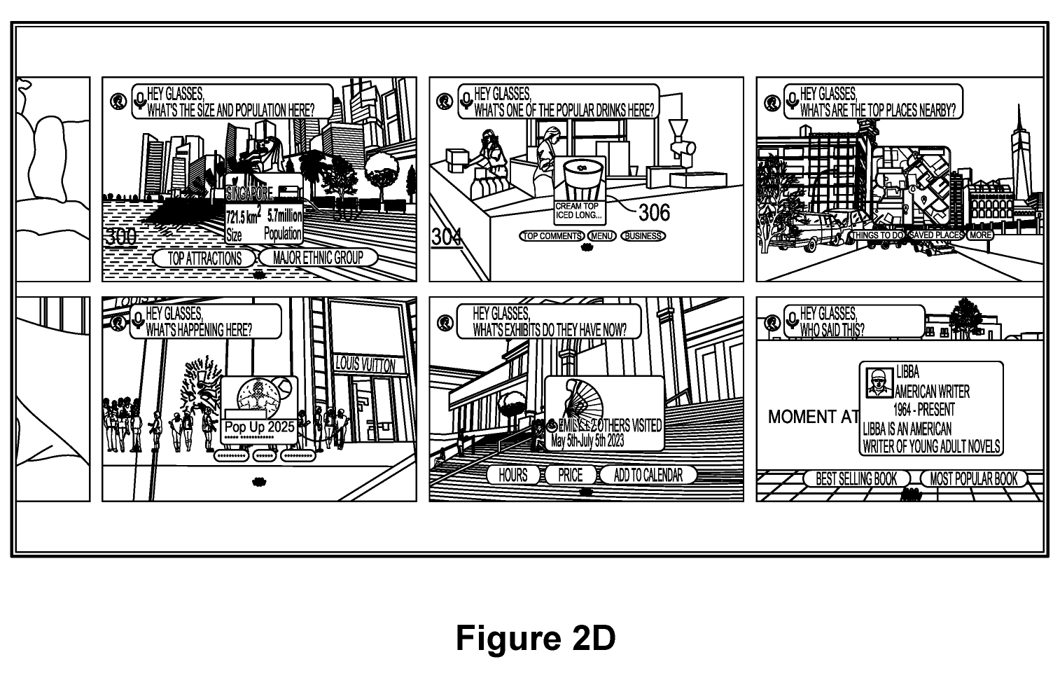

FIGS. 2A to 2D illustrate embodiments of AI systems presenting user interfaces in response to open-ended queries provided by a user (e.g., voice commands), in accordance with some embodiments.

FIG. 2A illustrates an entry point user interface 200 being presented, in which an AI (e.g., an AI assistive system) can provide information to a wearer of an augmented-reality headset based on what a camera of the augmented-reality headset is viewing and/or what the user has viewed (e.g., within a threshold recency time, for a threshold gaze duration), in accordance with some embodiments. Specifically, FIG. 2A shows a user querying an AI assistant with an open-ended query 206 of “where is this quote from?” With the open-ended query 206 the AI assistant can process the surrounding environment to provide further context to the open-ended question. In this example 200 the AI assistant can determine that the quote referenced in the open-ended query 206 the quote 202 displayed in the surrounding environment 204.

FIG. 2A illustrates that the AI, in response to the open ended-query an AR augment 208 is displayed, provides an answer to the open-ended query. As shown, based on the type of query and/or surrounding context the AR augment 208 can have a certain design (e.g., an image and text of a first size) that can include contextual follow-up queries (e.g., a first AR follow-up query augment 210A and second AR follow-up query augment 210B). In some embodiments, an open-ended query is a query if viewed in isolation without external data could not be answered, but is able to be answered when contextual data provided outside of query is given.

FIG. 2B shows a second example field of view 212 of the user 1202 which shows the user 1202 querying an AI assistant with a voice command 214, which the AI assistant may identify as an open-ended query (stating “Hey glasses what’s the size and population here?”).

Based on the open-ended query identified from the voice command 214 of the user 1202, the AI assistant can use various sensors of the process the surrounding environment to provide further context to the open-ended query. As such, the AI assistant is able to respond with an answer that, in this example, uses location sensors to provide an answer to the query. The AI assistant is able to selectively use data of different sensors of the AR headset to prepare responses to the open-ended query. Based on selectively using the data from the different sensors, the AR headset presents a set of user interface elements that are responsive to the user’s query. The set of user interface elements include an informational user interface element presenting a representation of data that is responsive to the open-ended query identified based on the user’s voice command.

FIG. 2C shows a third example 216 in which the user 1202 provides a voice command 218, which an open-ended query and the AI assistant leverages multiple data sources. In this example, the user is provided with an answer to the open-ended query based on location data and data from other applications installed on the head-wearable device (e.g., information from a social media application, such as who has visited the location).

FIG. 2D shows multiple example interactions in which the AI assistant can leverage data from different sources to answer open ended queries and then present user interfaces with various formats that provide respective answers and other information in different formats based on the answer, in accordance with some embodiments. For example, FIG. 2D shows in a first pane 300 that in response to open ended query about the population, an XR augment 302 is shown that provides information in a first manner. FIG. 2D also shows in a second pane 304 that in response to a different open-ended query, an XR augment 306 is shown that provides information in a second manner. The information provided in the second manner may differ from the information provided in the first manner, e.g., based on the information needing to be presented based on the open-ended query. As seen in the other panes, the information can include but is not limited to one or more of images, reviews, social media information, textual information, video, suggested follow-up queries, etc.

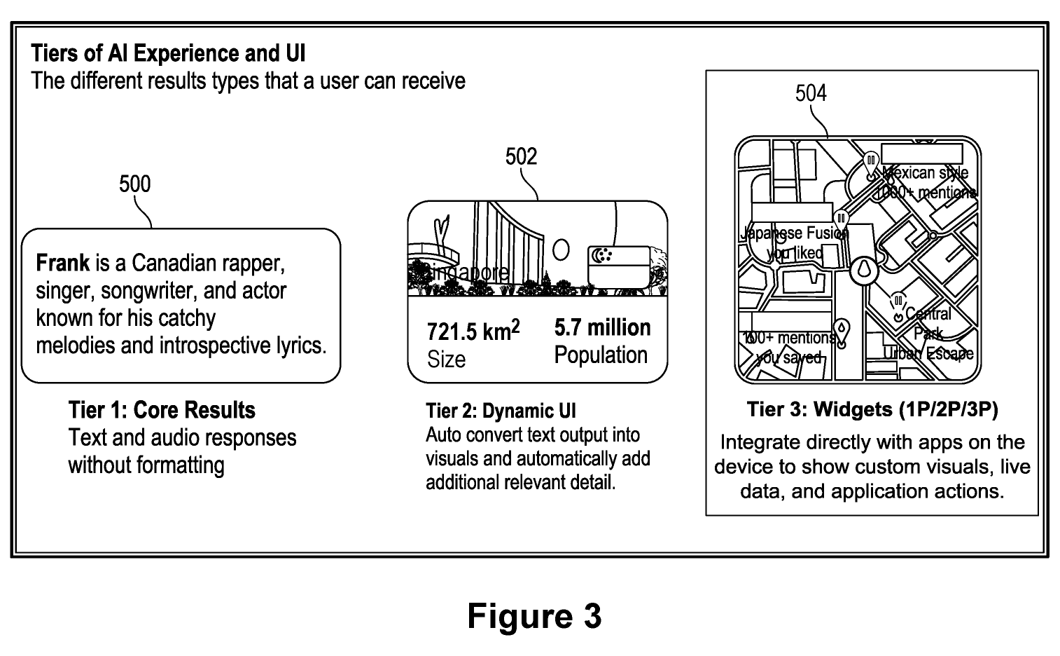

FIG. 3 shows examples of various different XR augments that can be presented to a user based on their open-ended query, in accordance with some embodiments. For example, FIG. 3 includes a first XR augment 500 that provides an automatically generated responses to open-ended queries using text and audio responses (e.g., with or without formatting). A second XR augment 502 is shown in FIG. 3 in which the automatically generated response to an open-end query includes text and visuals (e.g., a relevant image 504) to provide additional details to the user (e.g., visuals related to the query).

FIG. 3 further shows a third XR augment that is able to display user interfaces that are derived automatically from applications installed on the device (e.g., the XR augment can include custom visuals, live data, and application actions derived from applications installed on the device). In some embodiments, these interfaces can be widgets (e.g., light-weight applications) installed on the device.

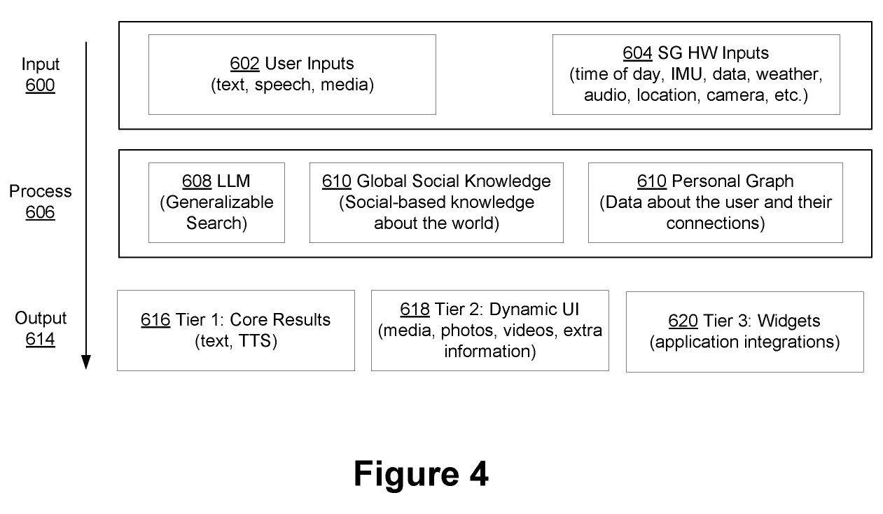

FIG. 4 illustrates a block diagram of components (which may include software and/or hardware of the computing systems described herein) that are used to process open-ended queries as described herein, in accordance with some embodiments. FIG. 4 shows three high-level steps in which an open-ended-query is answered. The first high-level step is the input step 600 which includes (i) user input (e.g., text, speech, media) 602 and (ii) smart glasses hardware inputs 604 (e.g., time of day, inertial measurement unit (IMU), date, weather, audio, location, camera). The second high-level step is the processing step 606 which processes input using a combination of one or more of (i) a large language model (LLM) for a generalizable search 608, (ii) global social knowledge that utilizes general social knowledge from social media sources 610, and/or (iii) a personal graph that utilizes user-specific social media information 612 (e.g., connection information, user interactions, etc.). The third high-level step is the output step 614, which provides at least three different types of output based on the provided input and processing occurring. The three different types of outputs can include (i) core results that include text and/or text to speech 616, (ii) a dynamic user interface that includes additional information 618 such as media, photos, videos, extra information, etc., (iii) widgets 620 which allow for other applications installed on the headset to integrate with the output.

As briefly described, the interactions described herein allow for minimal consumption and promotes quick interactions. For example the interactions can be faster than pulling out your phone an using it. In addition, the interactions are also silent and private such that interactions are completed silently and privately without revealing the user’s interaction to the world around them. Additionally, an AI ecosystem can be used to create widgets that bring 1P (first party applications), 2P (second party applications), and 3P (third party applications) experiences to the smart glasses. In addition, a proactive AI can use an LLM, a social graph, and the passage of time to provide personalized experiences and information tailored to the user. Further, the ecosystem described herein can be used across varying devices (e.g., AR headsets, MR headsets, and budget friendly headsets) with different feature sets (e.g., the AI can adjust the output based on the output modalities at its disposal). In accordance with some embodiments, the AI ecosystem facilitating the interactions at the AR headset can include more integrations as the number of use cases increases. In this example, a music app, a rental car app, and a ride share app can utilize AI enhanced interactions described herein.

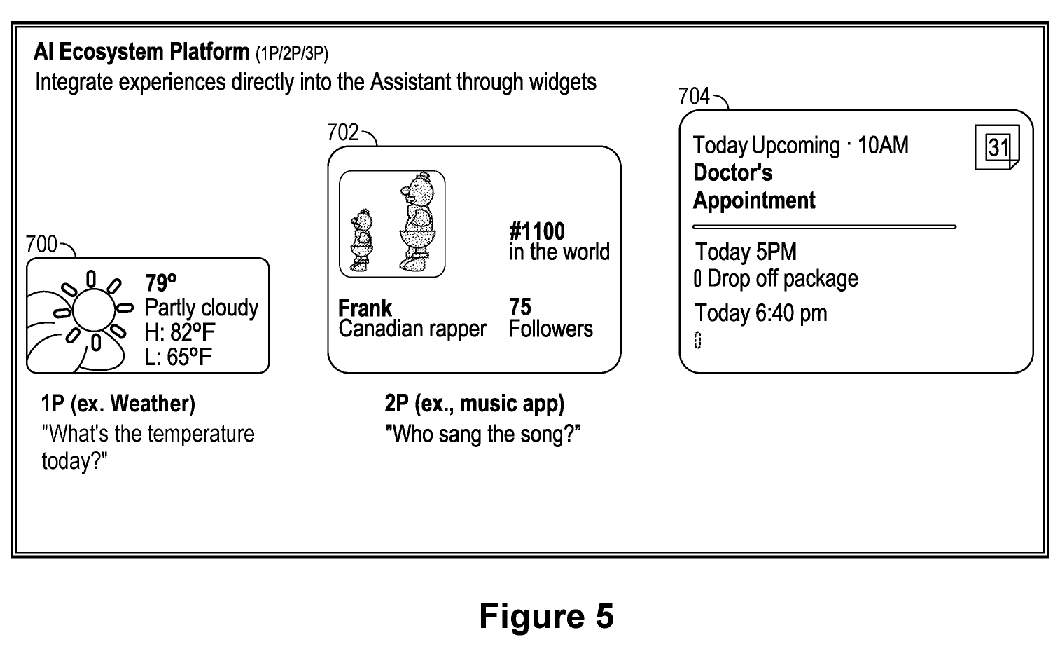

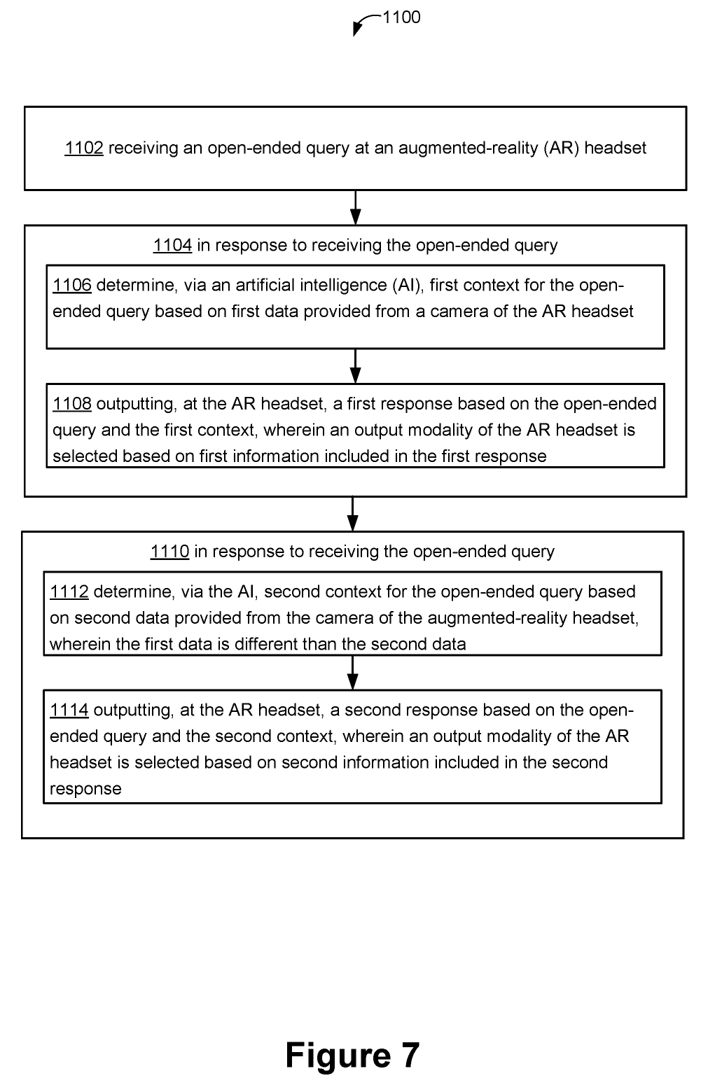

FIG. 5 illustrates examples of different widget AR augments an AI can automatically prepare, in accordance with some embodiments. The AI can leverage different applications installed on the pair of smart glasses to produce different widgets. For example, FIG. 5 shows an AR augment 700 generated by an AI using information sourced from a first party application installed on the AR glasses. In another example, FIG. 7 shows AR augment 702 generated by an AI using information sourced from a second party application installed on the AR glasses (e.g., at least some of the data is stored locally or stored on first party servers). In another example, FIG. 5 shows AR augment 704 generated by an AI using information sourced from a third-party application installed on the AR glasses (e.g., the data is stored on third party servers).

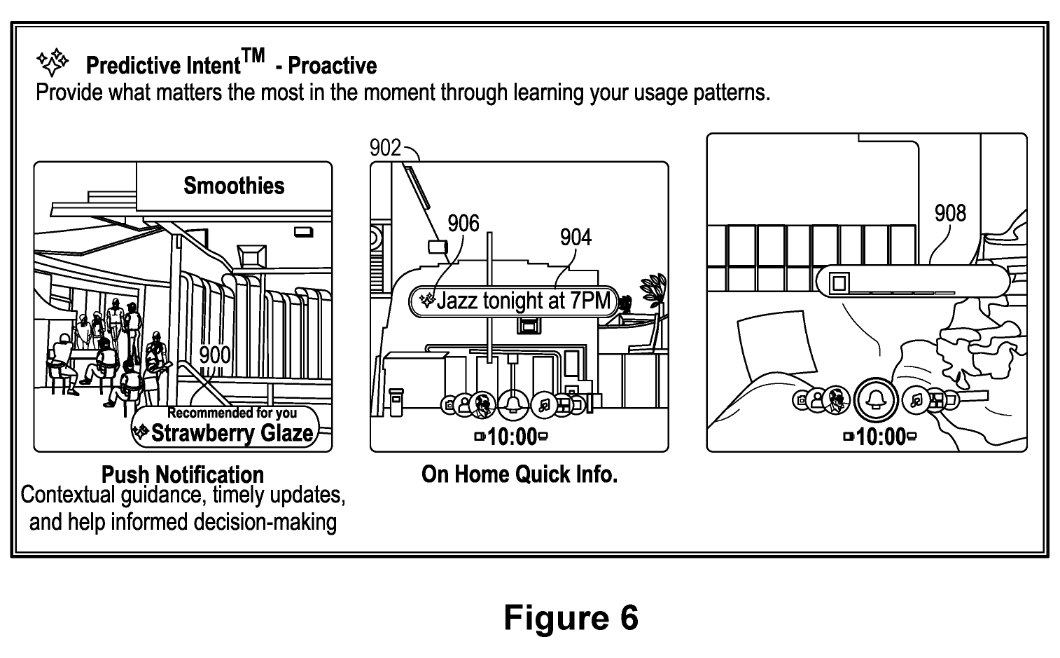

FIG. 6 shows different ways an AI assistant can proactively provide entry points for interacting with an artificial intelligence assistant, in accordance with some embodiments. In other words, the AI assistant can surface XR augments for providing a way to interact with the AR headset without the user needing to prompt the AI. These proactive entry points can vary an can be generated using usage patterns and other information. For example, FIG. 6 shows a first example, in which a XR augment push notification 900 is provided to the used based on location and previous interactions (e.g., the user regularly orders a certain type of smoothie when visiting a specific smoothie shop). Push notifications generated by an AI can include but are not limited to, contextual guidance, time sensitive updates, and providing help to make informed decision making.

FIG. 6 shows a second example in which a relevant information based on user context and location is presented at the home screen XR augment 902 includes a XR augment 904 for providing relevant information (e.g., a reminder for an event) based on user context and location without requiring the user to perform an interaction with the device. As shown, the XR augment can include a glyph 906 for indicating that the XR augment is AI generated.

FIG. 6 shows a third example in which an AI can generate XR augment 908 to provide a user with live updates based on real-time information. These live update XR augments can be configured to provide real-time estimates of deliveries, orders, or other interaction in which timeliness of notifications is relevant. These XR augments of FIG. 6 are frictionless, which means the user does not need to set up the notifications beforehand or access an application on the device. Instead, the AI can determine when it is appropriate to present the notification without any kind of user input.

The AI ecosystem described herein can be an action bases system infrastructure. An action-based system infrastructure allows provides a scalable system that allows information to be visualized and provide actions from applications without needing to launch applications or navigate application traditional user interfaces to perform operations. This action-based system allows flexibility to create XR augments and interactions with having to redo system integrations. This further provides the flexibility to iterate and integrate across a variety of devices.

FIG. 7 illustrates a flow diagram of a method of receiving an open-ended query and providing a response based on the open-ended query, in accordance with some embodiments. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) FIG. 7 shows a flow chart of a method 1100 of receiving an open-ended query and providing a response based on the open-ended query, in accordance with some embodiments. The method 1100 comprises receiving 1102 an open-ended query at an augmented-reality (AR) headset (e.g., FIG. 2A illustrates example open ended queries received at an AR headset). The method also includes that in response to receiving the open-ended query (1104): determining (1106), via an artificial intelligence (AI), first context for the open-ended query based on first data provided from a camera of the AR headset (e.g., FIG. 2A shows different types of open-ended queries that cannot have an answer provided unless additional context is provided); and (1108) outputting, at the AR headset, a first response based on the open-ended query and the first context, wherein an output modality of the AR headset is selected based on first information included in the first response (e.g., FIG. 2A shows that an AI generates a response to the open-ended query using additional context based on different data sources (e.g., camera data)). The method also includes that in response to receiving the open-ended query (1110): determining (1112), via the AI, second context for the open-ended query based on second data provided from the camera of the augmented-reality headset, wherein the first data is different than the second data e.g., FIG. 2A shows different types of open-ended queries that cannot have an answer provided unless additional context is provided); and outputting (1114), at the AR headset, a second response based on the open-ended query and the second context, wherein an output modality of the AR headset is selected based on second information included in the second response e.g., FIG. 2A shows that an AI generates a response to the open-ended query using additional context based on different data sources (e.g., camera data)).

(A2) In some embodiments of A1, the open-ended query on its own does not include sufficient information for outputting the first response or second response (e.g., FIG. 2A shows an open-ended query that states “where is this quote from?” without providing the quote, and the AI assistant is able to recognize text in data provided by a camera of the AR headset).

(A3) In some embodiments of any of A1-A2, the output modality is selected from one or more of: media, text, text-to-speech, social media information and/or a widget application. For example, FIG. 2A shows a speech-based open-ended query being provided to the AI assistant.

(A4) In some embodiments of any of A1-A3, the first context for the open-ended query is further based on location data, time of day, IMU data, date, weather data, audio data, and/or application data and the second context for the open-ended query is further based on location data and/or application data. For example, FIG. 4 illustrates a framework in which the AI can leverage data from multiple sources to provide a response to the open-ended query.

(A5) In some embodiments of any of A1-A4, the first response includes one or more extended-reality augments that provide predictive follow-up operations to be performed based on the open-ended query and the first context. For example, FIG. 1 shows XR augment 400 also includes a predictive intent region 404 that provides additional operations for the head-wearable device to perform.

(A6) In some embodiments of any of A1-A5, the first response is generated using a large language model (LLM) and one or more of general social media information and personalized social media information. For example, FIG. 4 shows that an LLM is utilized in preparing the response to the open-ended query.

(A7) In some embodiments of any of A1-A6, the first response includes a first XR augment that has a first size and the second response includes a second XR augment that a second size that is different than the first size.

(A8) In some embodiments of any of A1-A7, the method further comprises in accordance with a determination, via the AI, that data indicates that the AR headset is following a repeated pattern, outputting, at the AR headset, a predicted operation or information based on the repeated pattern, wherein outputting the predicted operation or information occurs automatically without human intervention. FIG. 9 illustrates a few examples in which an AI can monitor patterns associated with the user and provide anticipatory operations and information, thereby reducing user friction when using the AR headset.

(A9) In some embodiments of A8, the predicted operation or information is presented as a push notification displayed at the AR headset. FIG. 6 shows a few instances in which push notifications that are generated by the AI can be proactively presented to the user.

(A10) In some embodiments of A8, the predicted operation or information can be one or more of contextual guidance, time-sensitive updates, and information for assisting in decision making of a wearer.

(A11) In some embodiments of any of A1-A10, the first response includes information from a second-party source or a third-party source. FIG. 7 illustrates how first party, second party, and third-party applications and data can be used as data sources for providing information used in the response generated by the AI.

(A12) In some embodiments of A11, the information from the second-party source or the third-party source is from an application installed on the AR headset. For example, FIG. 7 shows AR augment 704 generated by an AI using information sourced from a third-party application installed on the AR headset.

(A13) In some embodiments of any of A1-A12, the open-ended query can include one or more of text, speech or media. FIG. 6 illustrates that user input can be one or more text, speech, or media.

In accordance with some embodiments, the AI can produce personalized XR augments based on user’s data and interactions with the AR headset and AI assistant. For example, in some embodiments, a first subset of XR augments can be generated for a user who is classified by the AI as a fashionista. And a second subset of XR augments that an AI can be generated for another user who is classified by the AI as an outdoor adventurer. And a third subset 1004 of XR augments that an AI can generate for a user who is classified by the AI as a foodie. Although these examples are explicitly described, the AI can create a personalized experience for any user and their particular interests or combination of interests.

(B1) In accordance with some embodiments, a non-transitory, computer-readable storage medium including executable instructions that, when executed by one or more processors, cause the one or more processors to perform or cause performance of the methods of any of A1-A13.

(C1) In accordance with some embodiments, means for performing or causing performance of the methods of any one of A1 to A13.

(D1) In accordance with some embodiments, a wearable device (head-worn or wrist-worn) configured to perform or cause performance of the methods of any one of A1 to A13.

(E1) In accordance with some embodiments, an intermediary processing device (e.g., configured to offload processing operations for a head-worn device such as Augmented Reality glasses) configured to perform or cause performance of the methods of any one of A1 to A13.

### Example Extended-Reality Systems

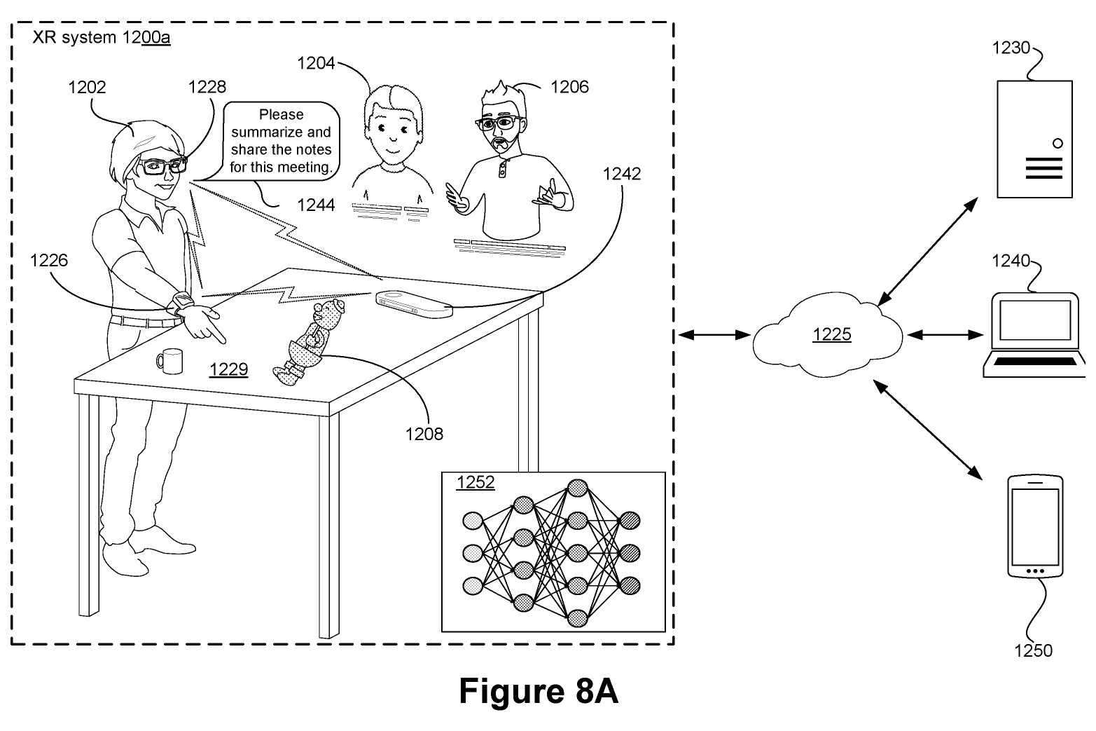

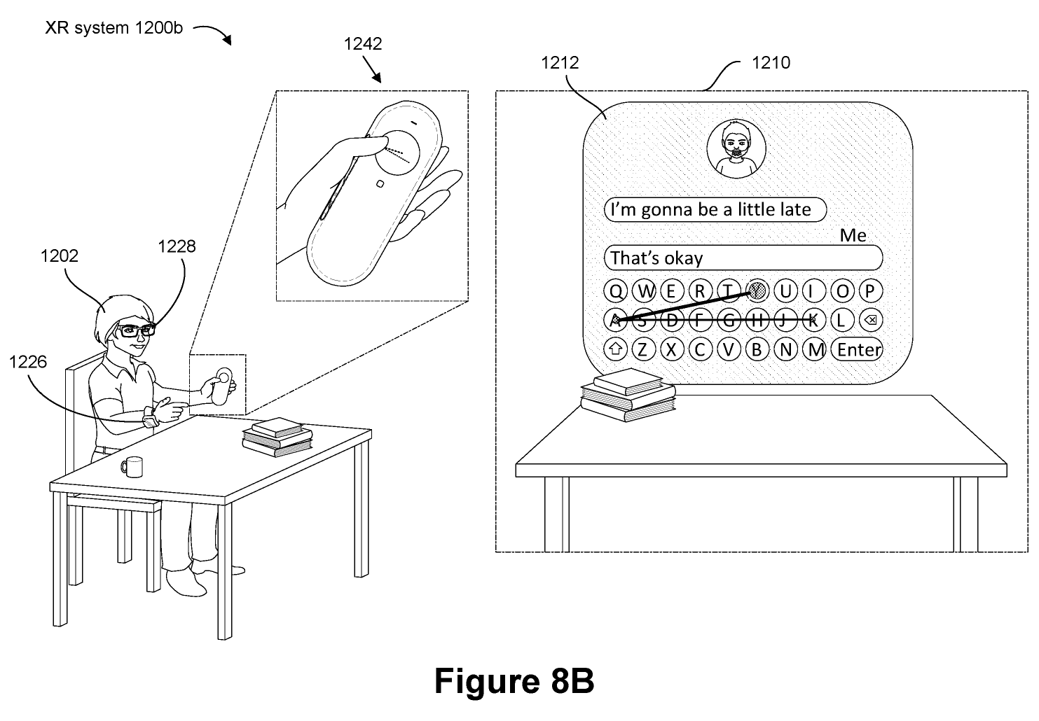

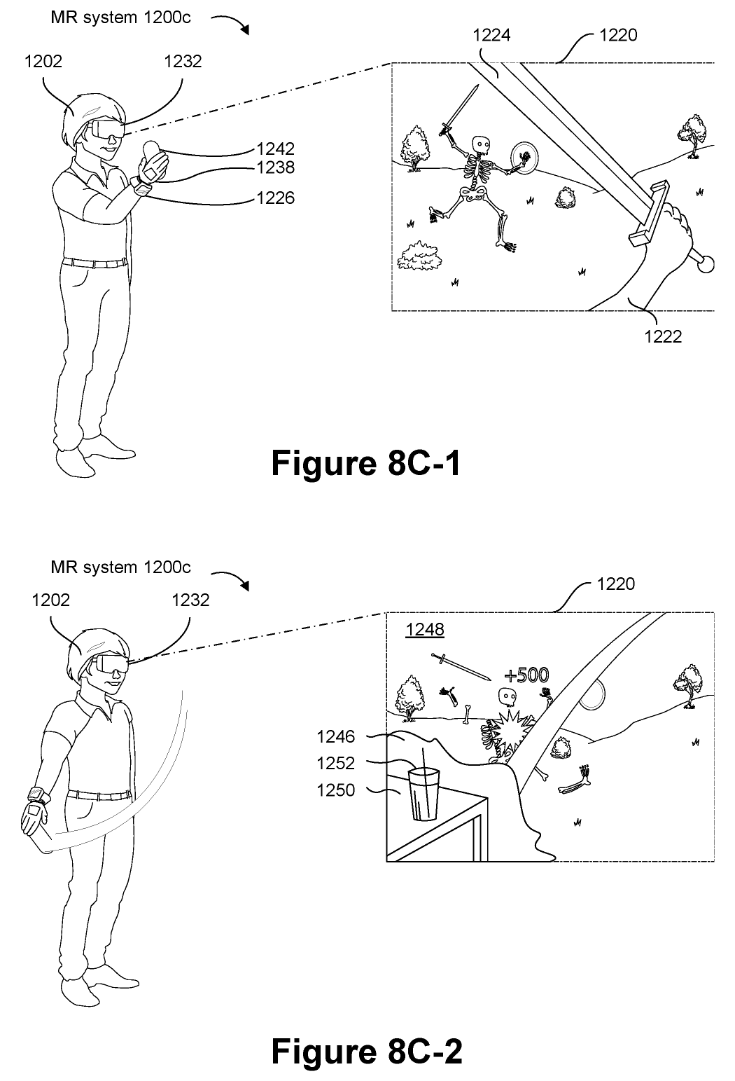

FIGS. 8A 8B, 8C-1, and 8C-2, illustrate example XR systems that include AR and MR systems, in accordance with some embodiments. FIG. 8A shows a first XR system 1200a and first example user interactions using a wrist-wearable device 1226, a head-wearable device (e.g., AR device 1228), and/or a HIPD 1242. FIG. 8B shows a second XR system 1200b and second example user interactions using a wrist-wearable device 1226, AR device 1228, and/or an HIPD 1242. FIGS. 8C-1 and 8C-2 show a third MR system 1200c and third example user interactions using a wrist-wearable device 1226, a head-wearable device (e.g., an MR device such as a VR device), and/or an HIPD 1242. As the skilled artisan will appreciate upon reading the descriptions provided herein, the above-example AR and MR systems (described in detail below) can perform various functions and/or operations.

The wrist-wearable device 1226, the head-wearable devices, and/or the HIPD 1242 can communicatively couple via a network 1225 (e.g., cellular, near field, Wi-Fi, personal area network, wireless LAN). Additionally, the wrist-wearable device 1226, the head-wearable device, and/or the HIPD 1242 can also communicatively couple with one or more servers 1230, computers 1240 (e.g., laptops, computers), mobile devices 1250 (e.g., smartphones, tablets), and/or other electronic devices via the network 1225 (e.g., cellular, near field, Wi-Fi, personal area network, wireless LAN). Similarly, a smart textile-based garment, when used, can also communicatively couple with the wrist-wearable device 1226, the head-wearable device(s), the HIPD 1242, the one or more servers 1230, the computers 1240, the mobile devices 1250, and/or other electronic devices via the network 1225 to provide inputs.

Turning to FIG. 8A, a user 1202 is shown wearing the wrist-wearable device 1226 and the AR device 1228 and having the HIPD 1242 on their desk. The wrist-wearable device 1226, the AR device 1228, and the HIPD 1242 facilitate user interaction with an AR environment. In particular, as shown by the first AR system 1200a, the wrist-wearable device 1226, the AR device 1228, and/or the HIPD 1242 cause presentation of one or more avatars 1204, digital representations of contacts 1206, and virtual objects 1208. As discussed below, the user 1202 can interact with the one or more avatars 1204, digital representations of the contacts 1206, and virtual objects 1208 via the wrist-wearable device 1226, the AR device 1228, and/or the HIPD 1242. In addition, the user 1202 is also able to directly view physical objects in the environment, such as a table 1229, through transparent lens(es) and waveguide(s) of the AR device 1228. Alternatively, an MR device could be used in place of the AR device 1228 and a similar user experience can take place, but the user would not be directly viewing physical objects in the environment, such as table 1229, and would instead be presented with a virtual reconstruction of the table 1229 produced from one or more sensors of the MR device (e.g., an outward facing camera capable of recording the surrounding environment).

The user 1202 can use any of the wrist-wearable device 1226, the AR device 1228 (e.g., through physical inputs at the AR device and/or built-in motion tracking of a user’s extremities), a smart-textile garment, externally mounted extremity tracking device, the HIPD 1242 to provide user inputs, etc. For example, the user 1202 can perform one or more hand gestures that are detected by the wrist-wearable device 1226 (e.g., using one or more EMG sensors and/or IMUs built into the wrist-wearable device) and/or AR device 1228 (e.g., using one or more image sensors or cameras) to provide a user input. Alternatively, or additionally, the user 1202 can provide a user input via one or more touch surfaces of the wrist-wearable device 1226, the AR device 1228, and/or the HIPD 1242, and/or voice commands captured by a microphone of the wrist-wearable device 1226, the AR device 1228, and/or the HIPD 1242. The wrist-wearable device 1226, the AR device 1228, and/or the HIPD 1242 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1228 (e.g., via an input at a temple arm of the AR device 1228). In some embodiments, the user 1202 can provide a user input via one or more facial gestures and/or facial expressions. For example, cameras of the wrist-wearable device 1226, the AR device 1228, and/or the HIPD 1242 can track the user 1202’s eyes for navigating a user interface.

The wrist-wearable device 1226, the AR device 1228, and/or the HIPD 1242 can operate alone or in conjunction to allow the user 1202 to interact with the AR environment. In some embodiments, the HIPD 1242 is configured to operate as a central hub or control center for the wrist-wearable device 1226, the AR device 1228, and/or another communicatively coupled device. For example, the user 1202 can provide an input to interact with the AR environment at any of the wrist-wearable device 1226, the AR device 1228, and/or the HIPD 1242, and the HIPD 1242 can identify one or more back-end and front-end tasks to cause the performance of the requested interaction and distribute instructions to cause the performance of the one or more back-end and front-end tasks at the wrist-wearable device 1226, the AR device 1228, and/or the HIPD 1242. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1242 can perform the back-end tasks and provide the wrist-wearable device 1226 and/or the AR device 1228 operational data corresponding to the performed back-end tasks such that the wrist-wearable device 1226 and/or the AR device 1228 can perform the front-end tasks. In this way, the HIPD 1242, which has more computational resources and greater thermal headroom than the wrist-wearable device 1226 and/or the AR device 1228, performs computationally intensive tasks and reduces the computer resource utilization and/or power usage of the wrist-wearable device 1226 and/or the AR device 1228.

In the example shown by the first AR system 1200a, the HIPD 1242 identifies one or more back-end tasks and front-end tasks associated with a user request to initiate an AR video call with one or more other users (represented by the avatar 1204 and the digital representation of the contact 1206) and distributes instructions to cause the performance of the one or more back-end tasks and front-end tasks. In particular, the HIPD 1242 performs back-end tasks for processing and/or rendering image data (and other data) associated with the AR video call and provides operational data associated with the performed back-end tasks to the AR device 1228 such that the AR device 1228 performs front-end tasks for presenting the AR video call (e.g., presenting the avatar 1204 and the digital representation of the contact 1206).

In some embodiments, the HIPD 1242 can operate as a focal or anchor point for causing the presentation of information. This allows the user 1202 to be generally aware of where information is presented. For example, as shown in the first AR system 1200a, the avatar 1204 and the digital representation of the contact 1206 are presented above the HIPD 1242. In particular, the HIPD 1242 and the AR device 1228 operate in conjunction to determine a location for presenting the avatar 1204 and the digital representation of the contact 1206. In some embodiments, information can be presented within a predetermined distance from the HIPD 1242 (e.g., within five meters). For example, as shown in the first AR system 1200a, virtual object 1208 is presented on the desk some distance from the HIPD 1242. Similar to the above example, the HIPD 1242 and the AR device 1228 can operate in conjunction to determine a location for presenting the virtual object 1208. Alternatively, in some embodiments, presentation of information is not bound by the HIPD 1242. More specifically, the avatar 1204, the digital representation of the contact 1206, and the virtual object 1208 do not have to be presented within a predetermined distance of the HIPD 1242. While an AR device 1228 is described working with an HIPD, an MR headset can be interacted with in the same way as the AR device 1228.

User inputs provided at the wrist-wearable device 1226, the AR device 1228, and/or the HIPD 1242 are coordinated such that the user can use any device to initiate, continue, and/or complete an operation. For example, the user 1202 can provide a user input to the AR device 1228 to cause the AR device 1228 to present the virtual object 1208 and, while the virtual object 1208 is presented by the AR device 1228, the user 1202 can provide one or more hand gestures via the wrist-wearable device 1226 to interact and/or manipulate the virtual object 1208. While an AR device 1228 is described working with a wrist-wearable device 1226, an MR headset can be interacted with in the same way as the AR device 1228.

### Integration of Artificial Intelligence with XR Systems

FIG. 8A illustrates an interaction in which an artificially intelligent virtual assistant can assist in requests made by a user 1202. The AI virtual assistant can be used to complete open-ended requests made through natural language inputs by a user 1202. For example, in FIG. 8A the user 1202 makes an audible request 1244 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 8A also illustrates an example neural network 1252 used in Artificial Intelligence applications. Uses of Artificial Intelligence (AI) are varied and encompass many different aspects of the devices and systems described herein. AI capabilities cover a diverse range of applications and deepen interactions between the user 1202 and user devices (e.g., the AR device 1228, an MR device 1232, the HIPD 1242, the wrist-wearable device 1226). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user’s request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1202 can interact with an AI model through natural language inputs captured by a voice sensor, text inputs, or any other input modality that accepts natural language and/or a corresponding voice sensor module. In another instance, input is provided by tracking the eye gaze of a user 1202 via a gaze tracker module. Additionally, the AI model can also receive inputs beyond those supplied by a user 1202. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 1228) or from multiple devices that are in communication with each other (e.g., a system that includes at least two of an AR device 1228, an MR device 1232, the HIPD 1242, the wrist-wearable device 1226, etc.). The AI model can also access additional information (e.g., one or more servers 1230, the computers 1240, the mobile devices 1250, and/or other electronic devices) via a network 1225.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1228, an MR device 1232, the HIPD 1242, the wrist-wearable device 1226) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1228, an MR device 1232, the HIPD 1242, the wrist-wearable device 1226), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1242), haptic feedback can provide information to the user 1202. An AI model can also use the inputs described above to determine the appropriate modality and device(s) to present content to the user (e.g., a user walking on a busy road can be presented with an audio output instead of a visual output to avoid distracting the user 1202).

### Example Augmented Reality Interaction

FIG. 8B shows the user 1202 wearing the wrist-wearable device 1226 and the AR device 1228 and holding the HIPD 1242. In the second AR system 1200b, the wrist-wearable device 1226, the AR device 1228, and/or the HIPD 1242 are used to receive and/or provide one or more messages to a contact of the user 1202. In particular, the wrist-wearable device 1226, the AR device 1228, and/or the HIPD 1242 detect and coordinate one or more user inputs to initiate a messaging application and prepare a response to a received message via the messaging application.

In some embodiments, the user 1202 initiates, via a user input, an application on the wrist-wearable device 1226, the AR device 1228, and/or the HIPD 1242 that causes the application to initiate on at least one device. For example, in the second AR system 1200b the user 1202 performs a hand gesture associated with a command for initiating a messaging application (represented by messaging user interface 1212); the wrist-wearable device 1226 detects the hand gesture; and, based on a determination that the user 1202 is wearing the AR device 1228, causes the AR device 1228 to present a messaging user interface 1212 of the messaging application. The AR device 1228 can present the messaging user interface 1212 to the user 1202 via its display (e.g., as shown by user 1202’s field of view 1210). In some embodiments, the application is initiated and can be run on the device (e.g., the wrist-wearable device 1226, the AR device 1228, and/or the HIPD 1242) that detects the user input to initiate the application, and the device provides another device operational data to cause the presentation of the messaging application. For example, the wrist-wearable device 1226 can detect the user input to initiate a messaging application, initiate and run the messaging application, and provide operational data to the AR device 1228 and/or the HIPD 1242 to cause presentation of the messaging application. Alternatively, the application can be initiated and run at a device other than the device that detected the user input. For example, the wrist-wearable device 1226 can detect the hand gesture associated with initiating the messaging application and cause the HIPD 1242 to run the messaging application and coordinate the presentation of the messaging application.

Further, the user 1202 can provide a user input provided at the wrist-wearable device 1226, the AR device 1228, and/or the HIPD 1242 to continue and/or complete an operation initiated at another device. For example, after initiating the messaging application via the wrist-wearable device 1226 and while the AR device 1228 presents the messaging user interface 1212, the user 1202 can provide an input at the HIPD 1242 to prepare a response (e.g., shown by the swipe gesture performed on the HIPD 1242). The user 1202’s gestures performed on the HIPD 1242 can be provided and/or displayed on another device. For example, the user 1202’s swipe gestures performed on the HIPD 1242 are displayed on a virtual keyboard of the messaging user interface 1212 displayed by the AR device 1228.

In some embodiments, the wrist-wearable device 1226, the AR device 1228, the HIPD 1242, and/or other communicatively coupled devices can present one or more notifications to the user 1202. The notification can be an indication of a new message, an incoming call, an application update, a status update, etc. The user 1202 can select the notification via the wrist-wearable device 1226, the AR device 1228, or the HIPD 1242 and cause presentation of an application or operation associated with the notification on at least one device. For example, the user 1202 can receive a notification that a message was received at the wrist-wearable device 1226, the AR device 1228, the HIPD 1242, and/or other communicatively coupled device and provide a user input at the wrist-wearable device 1226, the AR device 1228, and/or the HIPD 1242 to review the notification, and the device detecting the user input can cause an application associated with the notification to be initiated and/or presented at the wrist-wearable device 1226, the AR device 1228, and/or the HIPD 1242.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1228 can present to the user 1202 game application data and the HIPD 1242 can use a controller to provide inputs to the game. Similarly, the user 1202 can use the wrist-wearable device 1226 to initiate a camera of the AR device 1228, and the user can use the wrist-wearable device 1226, the AR device 1228, and/or the HIPD 1242 to manipulate the image capture (e.g., zoom in or out, apply filters) and capture image data.

While an AR device 1228 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user’s hand or other suitable surface (e.g., a table, whiteboard). In yet another embodiment, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 8C-1 and 8C-2, the user 1202 is shown wearing the wrist-wearable device 1226 and an MR device 1232 (e.g., a device capable of providing either an entirely VR experience or an MR experience that displays object(s) from a physical environment at a display of the device) and holding the HIPD 1242. In the third AR system 1200c, the wrist-wearable device 1226, the MR device 1232, and/or the HIPD 1242 are used to interact within an MR environment, such as a VR game or other MR/VR application. While the MR device 1232 presents a representation of a VR game (e.g., first MR game environment 1220) to the user 1202, the wrist-wearable device 1226, the MR device 1232, and/or the HIPD 1242 detect and coordinate one or more user inputs to allow the user 1202 to interact with the VR game.

In some embodiments, the user 1202 can provide a user input via the wrist-wearable device 1226, the MR device 1232, and/or the HIPD 1242 that causes an action in a corresponding MR environment. For example, the user 1202 in the third MR system 1200c (shown in FIG. 8C-1) raises the HIPD 1242 to prepare for a swing in the first MR game environment 1220. The MR device 1232, responsive to the user 1202 raising the HIPD 1242, causes the MR representation of the user 1222 to perform a similar action (e.g., raise a virtual object, such as a virtual sword 1224). In some embodiments, each device uses respective sensor data and/or image data to detect the user input and provide an accurate representation of the user 1202’s motion. For example, image sensors (e.g., SLAM cameras or other cameras) of the HIPD 1242 can be used to detect a position of the HIPD 1242 relative to the user 1202’s body such that the virtual object can be positioned appropriately within the first MR game environment 1220; sensor data from the wrist-wearable device 1226 can be used to detect a velocity at which the user 1202 raises the HIPD 1242 such that the MR representation of the user 1222 and the virtual sword 1224 are synchronized with the user 1202’s movements; and image sensors of the MR device 1232 can be used to represent the user 1202’s body, boundary conditions, or real-world objects within the first MR game environment 1220.

In FIG. 8C-2, the user 1202 performs a downward swing while holding the HIPD 1242. The user 1202’s downward swing is detected by the wrist-wearable device 1226, the MR device 1232, and/or the HIPD 1242 and a corresponding action is performed in the first MR game environment 1220. In some embodiments, the data captured by each device is used to improve the user’s experience within the MR environment. For example, sensor data of the wrist-wearable device 1226 can be used to determine a speed and/or force at which the downward swing is performed and image sensors of the HIPD 1242 and/or the MR device 1232 can be used to determine a location of the swing and how it should be represented in the first MR game environment 1220, which, in turn, can be used as inputs for the MR environment (e.g., game mechanics, which can use detected speed, force, locations, and/or aspects of the user 1202’s actions to classify a user’s inputs (e.g., user performs a light strike, hard strike, critical strike, glancing strike, miss) or calculate an output (e.g., amount of damage)).

FIG. 8C-2 further illustrates that a portion of the physical environment is reconstructed and displayed at a display of the MR device 1232 while the first MR game environment 1220 is being displayed. In this instance, a reconstruction of the physical environment 1246 is displayed in place of a portion of the first MR game environment 1220 when object(s) in the physical environment are potentially in the path of the user (e.g., a collision with the user and an object in the physical environment are likely). Thus, this example MR game environment 1220 includes (i) an immersive VR portion 1248 (e.g., an environment that does not have a corollary counterpart in a nearby physical environment) and (ii) a reconstruction of the physical environment 1246 (e.g., table 1250 and a cup resting on the table). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1226, the MR device 1232, and/or the HIPD 1242 are described as detecting user inputs, in some embodiments, user inputs are detected at a single device (with the single device being responsible for distributing signals to the other devices for performing the user input). For example, the HIPD 1242 can operate an application for generating the first MR game environment 1220 and provide the MR device 1232 with corresponding data for causing the presentation of the first MR game environment 1220, as well as detect the user 1202’s movements (while holding the HIPD 1242) to cause the performance of corresponding actions within the first MR game environment 1220. Additionally or alternatively, in some embodiments, operational data (e.g., sensor data, image data, application data, device data, and/or other data) of one or more devices is provided to a single device (e.g., the HIPD 1242) to process the operational data and cause respective devices to perform an action associated with processed operational data.

In some embodiments, the user 1202 can wear a wrist-wearable device 1226, wear an MR device 1232, wear smart textile-based garments 1238 (e.g., wearable haptic gloves), and/or hold an HIPD 1242 device. In this embodiment, the wrist-wearable device 1226, the MR device 1232, and/or the smart textile-based garments 1238 are used to interact within an MR environment (e.g., any AR or MR system described above in reference to FIGS. 8A-8B). While the MR device 1232 presents a representation of an MR game (e.g., second MR game environment 1220) to the user 1202, the wrist-wearable device 1226, the MR device 1232, and/or the smart textile-based garments 1238 detect and coordinate one or more user inputs to allow the user 1202 to interact with the MR environment.

In some embodiments, the user 1202 can provide a user input via the wrist-wearable device 1226, an HIPD 1242, the MR device 1232, and/or the smart textile-based garments 1238 that causes an action in a corresponding MR environment. In some embodiments, each device uses respective sensor data and/or image data to detect the user input and provide an accurate representation of the user 1202’s motion. While four different input devices are shown (e.g., a wrist-wearable device 1226, an MR device 1232, an HIPD 1242, and a smart textile-based garment 1238) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1238) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile-based garments 1238 can be used in conjunction with an MR device and/or an HIPD 1242.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method, comprising:
receiving an open-ended query at an augmented-reality (AR) headset;
in response to receiving the open-ended query:
determine, via an artificial intelligence (AI) model, first context for the open-ended query based on first data provided from a camera of the AR headset; and
outputting, at the AR headset, a first response based on the open-ended query and the first context, wherein an output modality of the AR headset is selected based on first information included in the first response; and
in response to receiving the open-ended query:
determine, via the AI model, second context for the open-ended query based on second data provided from the camera of the AR headset, wherein the first data is different than the second data; and
outputting, at the AR headset, a second response based on the open-ended query and the second context, wherein another output modality of the AR headset is selected based on second information included in the second response.

2. The method of claim 1, wherein the open-ended query on its own does not include sufficient information for outputting the first or second response.

3. The method of claim 1, wherein the output modality is selected from one or more of: media, text, text-to-speech, social media information and/or a widget application.

4. The method of claim 1, wherein the first context for the open-ended query is further based on location data, time of day, IMU data, date data, weather data, audio data, and/or application data and the second context for the open-ended query is further based on location data and/or application data.

5. The method of claim 1, wherein the first response includes one or more extended-reality augments that provide predictive follow-up operations to be performed based on the open-ended query and the first context.

6. The method of claim 1, wherein the first response is generated using a large language model (LLM) and one or more of general social media information and personalized social media information.

7. The method of claim 1, wherein the first response includes a first XR augment that has a first size and the second response includes a second XR augment that a second size that is different than the first size.

8. The method of claim 1, further comprising:
in accordance with a determination, via the AI model, that data indicates that the AR headset is following a repeated pattern, outputting, at the AR headset, a predicted operation or information based on the repeated pattern, wherein outputting the predicted operation or information occurs automatically without human intervention.

9. A non-transitory, computer-readable storage medium including executable instructions that, when executed by one or more processors, cause operations comprising:
receiving an open-ended query at an AR headset;
in response to receiving the open-ended query:
determine, via an AI, first context for the open-ended query based on first data provided from a camera of the AR headset; and
outputting, at the AR headset, a first response based on the open-ended query and the first context, wherein an output modality of the AR headset is selected based on first information included in the first response; and
in response to receiving the open-ended query:
determine, via the AI model, second context for the open-ended query based on second data provided from the camera of the AR headset, wherein the first data is different than the second data; and
outputting, at the AR headset, a second response based on the open-ended query and the second context, wherein another output modality of the AR headset is selected based on second information included in the second response.

10. The non-transitory, computer-readable storage medium of claim 9, wherein the open-ended query on its own does not include sufficient information for outputting the first or second response.

11. The non-transitory, computer-readable storage medium of claim 9, wherein the output modality is selected from one or more of: media, text, text-to-speech, social media information and/or a widget application.

12. The non-transitory, computer-readable storage medium of claim 9, wherein the first context for the open-ended query is further based on location data, time of day, IMU data, date data, weather data, audio data, and/or application data and the second context for the open-ended query is further based on location data and/or application data.

13. The non-transitory, computer-readable storage medium of claim 9, wherein the first response includes one or more extended-reality augments that provide predictive follow-up operations to be performed based on the open-ended query and the first context.

14. The non-transitory, computer-readable storage medium of claim 9, wherein the first response is generated using an LLM and one or more of general social media information and personalized social media information.

15. A wearable device, comprising:
one or more processors; and
memory, comprising instructions that, when executed by the one or more processors, cause operations comprising:
receiving an open-ended query at an AR headset;
in response to receiving the open-ended query:
determine, via an AI, first context for the open-ended query based on first data provided from a camera of the AR headset; and
outputting, at the AR headset, a first response based on the open-ended query and the first context, wherein an output modality of the AR headset is selected based on first information included in the first response; and
in response to receiving the open-ended query:
determine, via the AI model, second context for the open-ended query based on second data provided from the camera of the AR headset, wherein the first data is different than the second data; and
outputting, at the AR headset, a second response based on the open-ended query and the second context, wherein another output modality of the AR headset is selected based on second information included in the second response.

16. The wearable device of claim 15, wherein the open-ended query on its own does not include sufficient information for outputting the first or second response.

17. The wearable device of claim 15, wherein the output modality is selected from one or more of: media, text, text-to-speech, social media information and/or a widget application.

18. The wearable device of claim 15, wherein the first context for the open-ended query is further based on location data, time of day, IMU data, date data, weather data, audio data, and/or application data and the second context for the open-ended query is further based on location data and/or application data.

19. The wearable device of claim 15, wherein the first response includes one or more extended-reality augments that provide predictive follow-up operations to be performed based on the open-ended query and the first context.

20. The wearable device of claim 15, wherein the first response is generated using an LLM and one or more of general social media information and personalized social media information.
